(19) United States
(12) Patent Application Publication
(10) Pub. No.: US 2014/0353561 A1
(43) Pub. Date: Dec. 4, 2014

(54) SYSTEM AND METHOD FOR GUIDING A CABLE

(71) Applicant: Verizon Patent and Licensing Inc., Basking Ridge, NJ (US)

(72) Inventors: David Z. Chen, Richardson, TX (US); Christina Colasanto, New Ipswich, NH (US)

(21) Appl. No.: 13/907,496

(22) Filed: May 31, 2013

(51) Int. Cl. G02B 6/44; G02B 6/54; H02G 1/08; G02B 6/52

(52) U.S. Cl. CPC G02B 6/4465; G02B 6/52; G02B 6/54; H02G 1/081; H02G 1/086
USPC 254/134.4; 254/134.3 CL

(57) ABSTRACT

An apparatus and method for pulling an article such as a cable are disclosed. The apparatus includes a body having a portion configured to releasably secure the article. A compression force can be applied to secure the article and prevent slippage. A connector is provided at an end of the apparatus to facilitate attachment of a guide such as a thread.

### BACKGROUND INFORMATION

As technology advances and the density of urban residential areas increases, deployment of the necessary infrastructure becomes increasingly difficult. Densely populated cities are not capable of easily accommodating new residential or commercial structures. It can also be difficult, both physically and administratively, to demolish existing structures in order to accommodate new ones. Nonetheless, it is still necessary to upgrade the infrastructure in order to keep up with consumer demands for the latest features and services.

One such infrastructure upgrade involves migration of voice and data communication services from metal (e.g., copper, aluminum, coaxial, etc.) to optical fiber (also referred to as fiber optics or simply fiber). In order to upgrade the infrastructure in this manner, it is necessary to first deploy the optical fiber cable from central hubs to various locations such as office buildings, apartment buildings, and single/multi-family homes. Further complicating this process is the fact that many urban residential areas have subterranean power and communication lines. It is therefore necessary to deploy the optical fiber lines underground and/or remove legacy cables. Additionally, installation within buildings requires passage of the optical fiber cables within existing structures, often without disturbing visible walls. This often involves complicated routes having numerous turns.

Optical fiber cables, however, are more delicate than legacy cables, and more difficult to deploy. Once inside a building, the optical fiber cable must be routed through multiple curves and turns prior to reaching a desired location. The optical fiber cable must also be protected in order to reduce the occurrence of damage during the routing process. Furthermore, many cities restrict the level of demolition allowed on roadways and the length of time allowed to complete construction. This results in many obstacles when optical fibers must be deployed.

Based on the foregoing, there is a need for an approach for quickly and easily installing cables in existing structures such as buildings, and also for upgrading legacy infrastructure for voice and data communications.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1A is a diagram of a pulling apparatus, according to one embodiment;

FIG. 1B is a diagram of a pulling apparatus in a compressed position, according to one embodiment;

FIG. 1C is a diagram of a pulling apparatus in a tensed position, according to one embodiment;

FIG. 2A is a diagram of a portion of the interior surface of the pulling apparatus of FIG. 1, according to one embodiment;

FIG. 2B is a cross-sectional view of protrusions shown in FIG. 2A, according to one embodiment;

FIG. 3 is a diagram of a pulling apparatus, according to another embodiment;

FIG. 4 is a diagram illustrating a cable being secured by a pulling apparatus, according to one embodiment;

FIGS. 5A-5C are diagrams illustrating a cable being secured by a pulling apparatus, according to another embodiment; and

FIG. 6 is a system capable of installing cables using a pulling apparatus, according to one embodiment.

### DESCRIPTION OF THE PREFERRED EMBODIMENT

An apparatus and method for pulling and installing cables, is described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

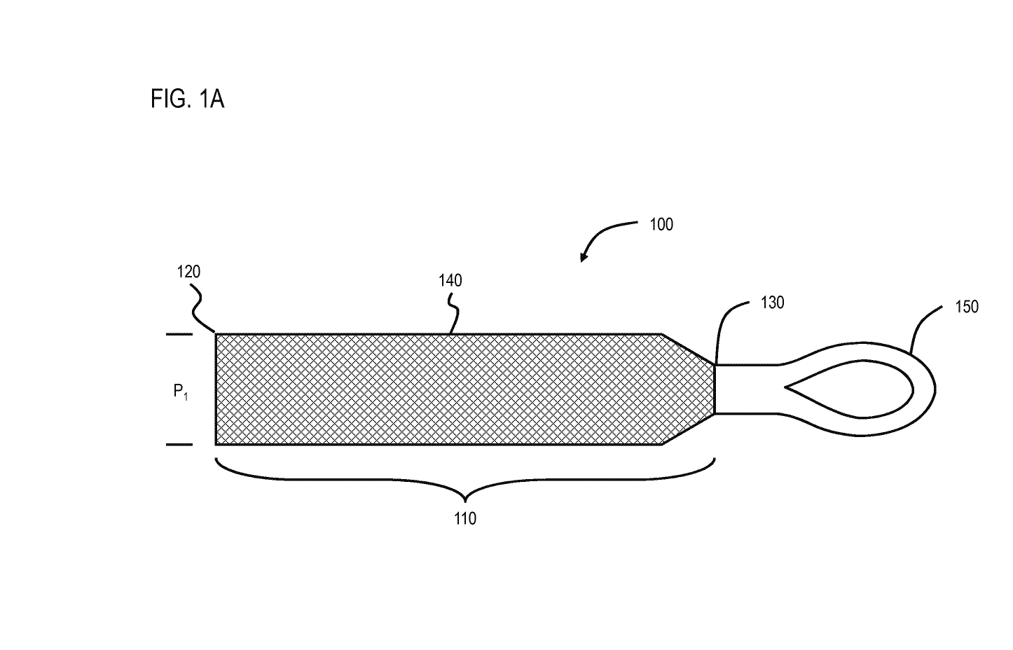

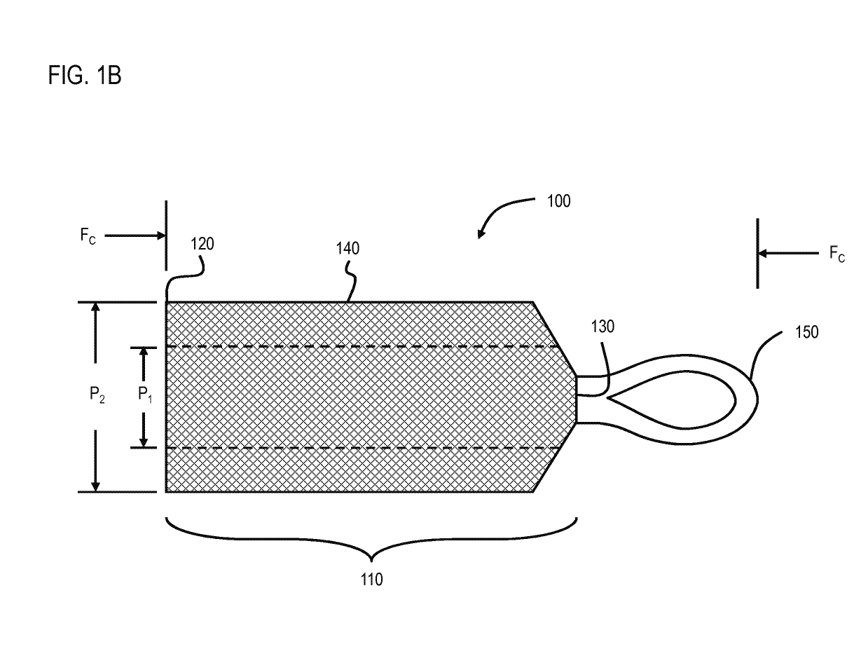

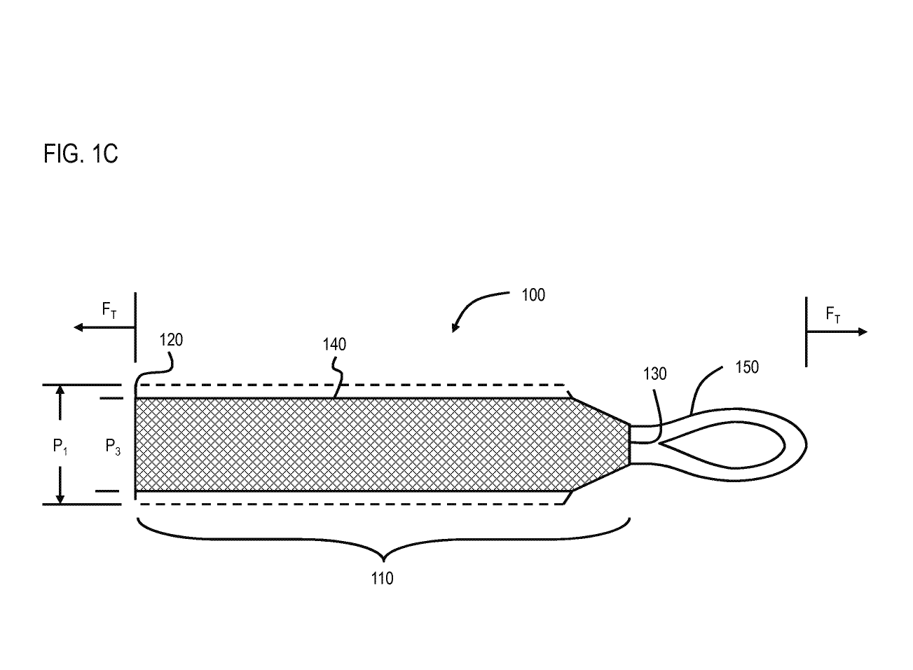

FIGS. 1A-1C are diagrams of an apparatus for pulling articles, such as cables, according to one embodiment. The pulling apparatus 100 includes a body 110 having a proximal end 120 and a distal end 130. The proximal end 120 of the body 110 also includes an opening which, as discussed in greater detail below, can be used to receive an article therein. The body 110 also includes a compression portion 140 defined by a predetermined section thereof. The compression portion 140 can be constructed as a net 142, or mesh, according to at least one embodiment of the invention. For example, the net 142 can be constructed by weaving nylon or metallic string. The net 142 can also be constructed by weaving strips of flexible materials such as nylon, cotton, etc. According to at least one embodiment, the material used to construct the net 142 can be woven in a biaxial braid pattern. Such braid patterns can be found, for example, in devices commonly known as Chinese handcuffs. Various other braid patterns can also be used as long as they provide sufficient flexibility and tension for retaining the article.

The compression portion 140 is used to secure the article received within the body 110. For example, depending on the specific requirements, the compression portion 140 can be defined by a substantial portion of the body 110 in order to increase the surface area available to contact the article inserted into the body 110. Alternatively, the compression portion 140 can be defined by a smaller portion of the body 110, thus reducing the surface area which contacts the article inside the body 110. A connector 150 is attached to the distal end 130 of the body 110, thereby closing the distal end 130. The connector 150 allows various items to be attached to pulling apparatus 100. Although the connector 150 is shown attached to the body 110, various embodiments facilitate a removable type connection as well as different types of connectors 150. For example, the connector 150 can be configured as male or female terminator. Such a configuration allows connection to a guide having a correspondingly terminated end. Thus, the connector can be securely coupled to the guide and pulled through a passage.

As illustrated in FIG. 1A, the pulling apparatus 100 is shown in a normal position designated by P1. In the normal position P1, no forces are being applied and the compression portion 140 is substantially at rest. Furthermore, as shown in FIG. 1A, no articles have been inserted in the body 110. Referring to FIG. 1B, the pulling apparatus 100 is shown under a condition where a compression force Fc is being applied. The compression force Fc causes the compression portion 140 to expand in diameter to position P2. As can be seen in FIG. 1B, the diameter of position P2 is greater than the diameter of position P1. Such an expansion allows articles of different sizes to be inserted into the pulling apparatus 100. Referring FIG. 1C, the pulling apparatus 100 is shown under a condition where a tensile force Ft is applied. The tensile force Ft results in a reduction of the diameter of the compression portion 140 relative to the normal position P1. Specifically, the diameter of the compression portion is reduced to the position identified by tensed position P3. The tensed position P3 can be seen to result in a smaller diameter relative to the normal position P1 identified by the broken lines. The reduction in diameter causes the compression portion 140 to come in contact with the article and secure it through a frictional, or other mechanically assisted, force. As the amount of tensile force Ft applied is increased, the diameter of compression portion is reduced, thereby increasing tension on the article.

According to different embodiments of the invention, however, various modifications can be made to increase the force for securing the article relative to simple contact friction. For example, the interior surface of the compression portion 140 can include one or more protrusions which extend in an outward manner. The interior surface of the compression portion can also include one or more suction cups or concave-type patterns which create a vacuum when the tensile force Ft is applied. Thus, when contacted with the article, the vacuum further increases the force retaining the article. The interior surface can also include one or more radial grooves which contact the article and increase the level of tension. Alternatively, the interior surface can include one or more ring portions which extend outwardly toward the center of compression portion 140. According to one or more embodiments, the ring portions and/or protrusions from the inner surface of the compression portion can have a reverse catch configuration designed to allow motion in one direction and prevent and/or reduce motion in an opposite direction. For example, such a configuration can allow an article to be inserted into the pulling apparatus 100, while preventing removal when the tensile force Ft is applied.

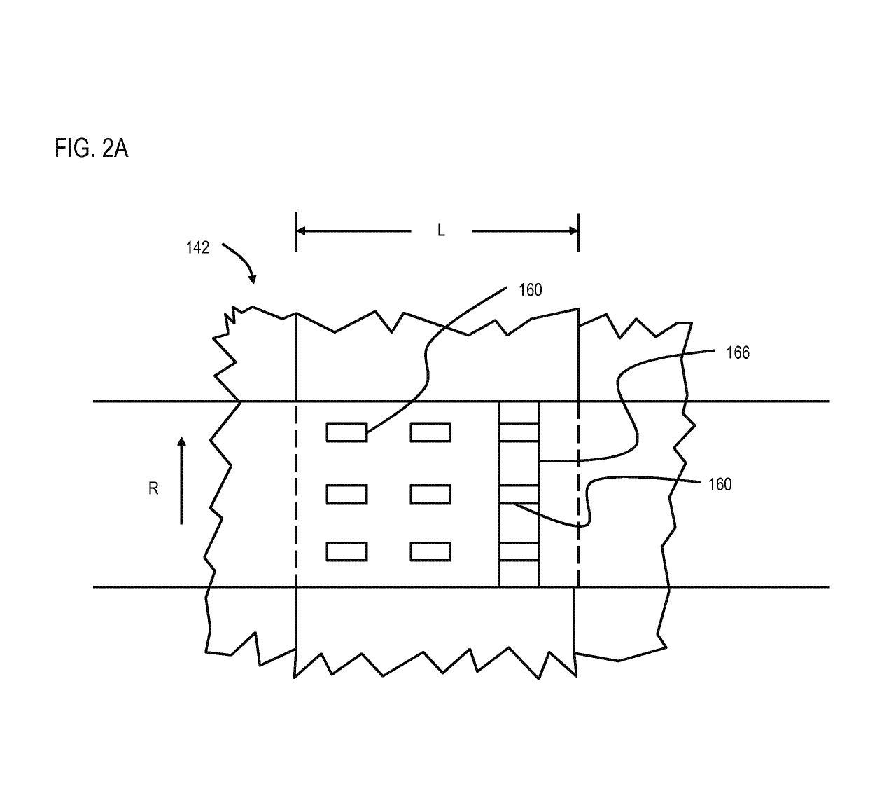

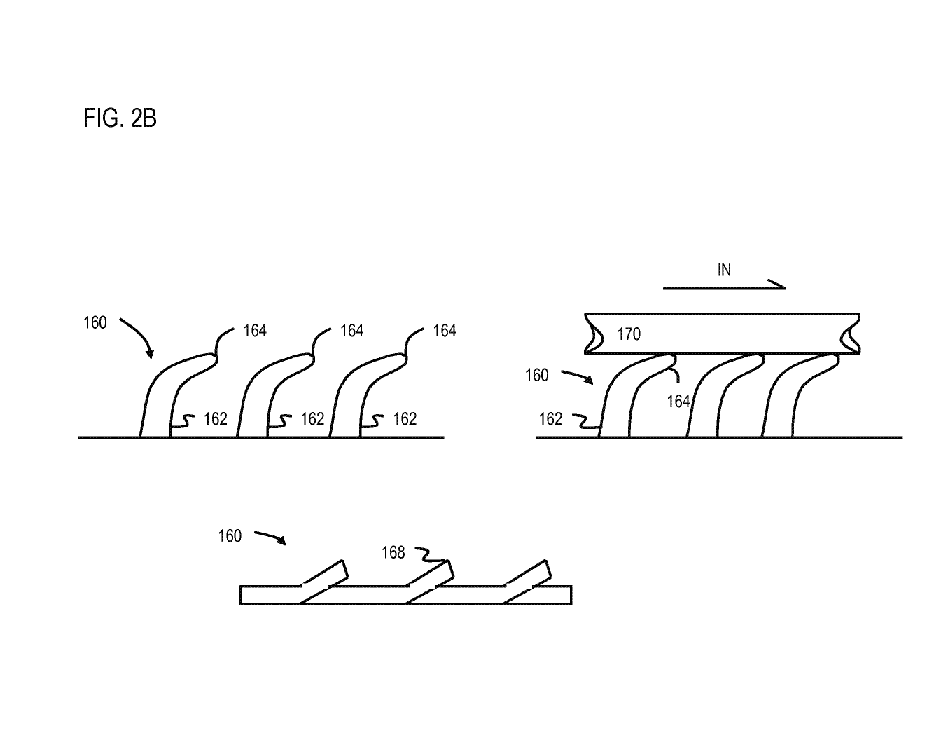

FIG. 2A is a diagram illustrating part of the interior surface of the compression portion 140, according to one exemplary embodiment. According to the illustrated embodiment, the compression portion 140 is formed by braiding one or more strips of material, for example, in the manner previously described. The interior surface of the compression portion 140 can include, for example, a plurality of protrusions 160. The protrusions 160 can be aligned with respect to both the longitudinal direction L and the radial direction R. The protrusions 160 can also be staggered and/or alternated. Additionally, one or more grooves 166 can be formed on the interior surface of the compression portion 140. According to at least one embodiment, one or more grooves 166 can be provided in conjunction with one or more protrusions 160.

Referring to FIG. 2B, an enlarged cross-section of the protrusion is illustrated, in accordance with one embodiment. As shown in the illustrated embodiment, each protrusion 160 includes a body portion 162 and an engaging portion 164. According to at least one embodiment, the engaging portion 164 can be oriented at a predetermined angle. According to other embodiments, the engaging portion 164 can extend from, and be substantially parallel to, the body portion 162. The engaging portion 164 can also be tapered, thereby resulting in a reduction in size relative to the body portion 162. According to at least one embodiment, the protrusions 160 can be formed by cutting sections 168 from the interior surface of the compression portion 140 such that one end is elevated to form the protrusions 160, while the other end remains attached. The result is a configuration wherein the protrusions 160 are arranged in a scale-like configuration. It should be appreciated that the protrusions shown in FIG. 2B are only intended to be illustrative, and are not limiting. Various shapes and configurations can be formed on the interior surface of the compression portion 140 so as to provide a rough surface, or a surface capable of generating increased friction.

When the compression portion 140 is compressed against an article such as cable 170, the protrusions 160 are pressed against the cable 170. As illustrated in FIG. 2B, protrusions 160 that are oriented at a predetermined angle can limit and/or restrict movement of the cable in a selected direction. For example, if the cable 170 is inserted into the pulling apparatus 100 along the direction identified as “IN”, the orientation of the engaging portion 164 can restrict movement of the cable 170 in an opposite direction. Such a feature can allow the cable 170 to be pulled via the connector 150 with reduced risk of being separated from the compression portion 140. Furthermore, any configuration of the compression portion 140 which increases friction with the cable can function to reduce the risk of separation when pulling the cable.

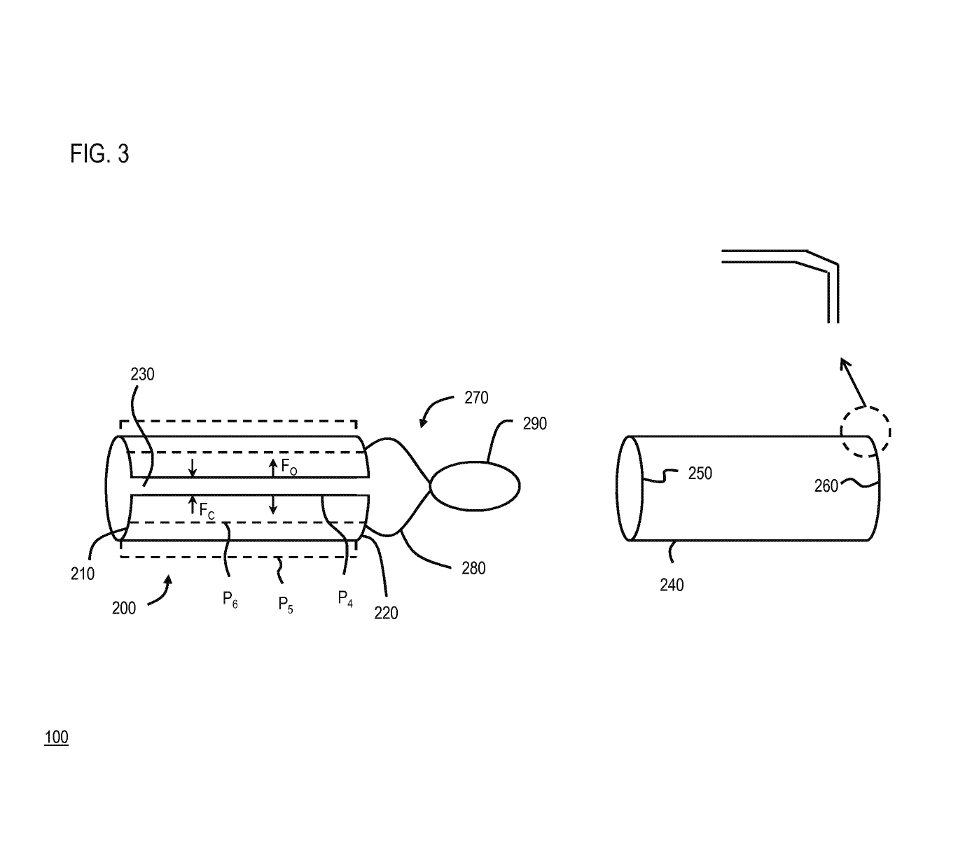

FIG. 3 illustrates a pulling apparatus 100 in accordance with one exemplary embodiment. The pulling apparatus 100 includes a compression sleeve 200 having a proximal end 210 and a distal end 220. A longitudinal slit 230 can be provided along at a portion of the compression sleeve 200. According to at least one embodiment, and as illustrated in FIG. 3, the longitudinal slit 230 extends the entire length of the compression sleeve 200. The longitudinal slit 230 allows the compression sleeve 200 to be expanded and contracted for accommodating cables having different diameters, and also to engage such cables within the pulling apparatus 100. More particularly, the longitudinal slit 230 normally allows the compression sleeve 200 to occupy a position identified by P4. This position also determines a diameter for the compression sleeve 200. However, the compression sleeve 200 can be expanded to another position identified by P5. As can be seen, at position P5, the longitudinal slit 230 is wider than position P5. The widened compression sleeve 200 is thus capable of easily receiving the cable 170 therein.

According to one or more embodiments, a compression force Fc can then be applied to the compression sleeve 200 in order to decrease the width of the longitudinal slit 230 to position P6. In this position, the compression sleeve 200 engages the cable 170 in order to restrict and/or prevent movement. The interior surface of the compression sleeve 200 can also be configured to increase the amount of force exerted on the cable 170. For example, one or more protrusions 160 which extend in an outward manner can be provided on the interior surface of the compression sleeve 200. The interior surface can also include one or more suction cups or concave-type patterns which create a vacuum when compression sleeve 200 is forced into position P6. Accordingly, when contacted with the cable 170, the vacuum force further increases the force retaining the cable 170. The interior surface can also include one or more radial grooves which contact the cable and increase the level of tension. Alternatively, the interior surface can include one or more ring portions, such as those shown in FIG. 2B, which extend outwardly toward the center of compression sleeve. The ring portions and protrusions from the inner surface of the compression sleeve can have a reverse catch configuration as shown in FIG. 2B.

The pulling apparatus 100 further includes an outer jacket 240 having a hollow interior. The outer jacket 240 also includes a proximal end 250 and a distal end 260. The outer jacket 240 is configured to receive the compression sleeve 200 and maintain a predetermined amount of force and/or diameter. According to one or more embodiments, the outer jacket 240 can be sized based on the specific function of the compression sleeve 200. For example, the outer jacket 240 can be sized to accommodate the compression sleeve 200 at any location between positions P5 and P6. Thus, if the compression sleeve 200 is expanded to accommodate a larger cable 170 than allowable by position P4, the outer jacket 240 could be sized appropriately between positions P4 and P5. Alternatively, if the compression sleeve 200 is forced to a position between P4 and P6, the outer jacket 240 can be appropriately sized to securely retain the cable 170. Regardless of the manner in which the outer jacket 240 is sized, a tight fit is formed between the compression sleeve 200 and the outer jacket 240, thereby securely retaining the compression sleeve 200. According to one or more embodiments, the distal end 260 of the outer jacket 240 included a taper, as shown in the enlarged portion, in order to allow smoother passage when the cable is being routed.

According to at least one embodiment, a connecting portion 270 can be provided at the distal end 220 of the compression sleeve 200. The connecting portion 270 allows attachment of a connector 290 to the pulling apparatus 100. For example, the connecting portion 270 can be configured as a pair of arms 280 connected to the distal end 220 of the compression sleeve 200. As illustrated in FIG. 3, the arms 280 are connected in such a manner that they do not affect opening and closing of the compression sleeve.

According to at least one embodiment, the pulling apparatus 100 can include both a compression portion 140 formed using a net 142, as well as an outer jacket 240. Specifically, the pulling apparatus 100 would include a body 110 for receiving the cable 170 therein. As previously discussed, the compression portion 142 can further include one or more protrusions 160 or other configurations intended to increase friction for retaining the cable 170. A connector 150 can also be provided at the distal end 130 of the body 110. According to such embodiments, the outer jacket 240 is provided to receive the body 110 and cable 170 therein. The outer jacket 240 is further sized such that a tight fit is formed over the body 110 of the pulling apparatus. Thus, the cable 170 can be pulled or blown while being securely retained by the pulling apparatus 100.

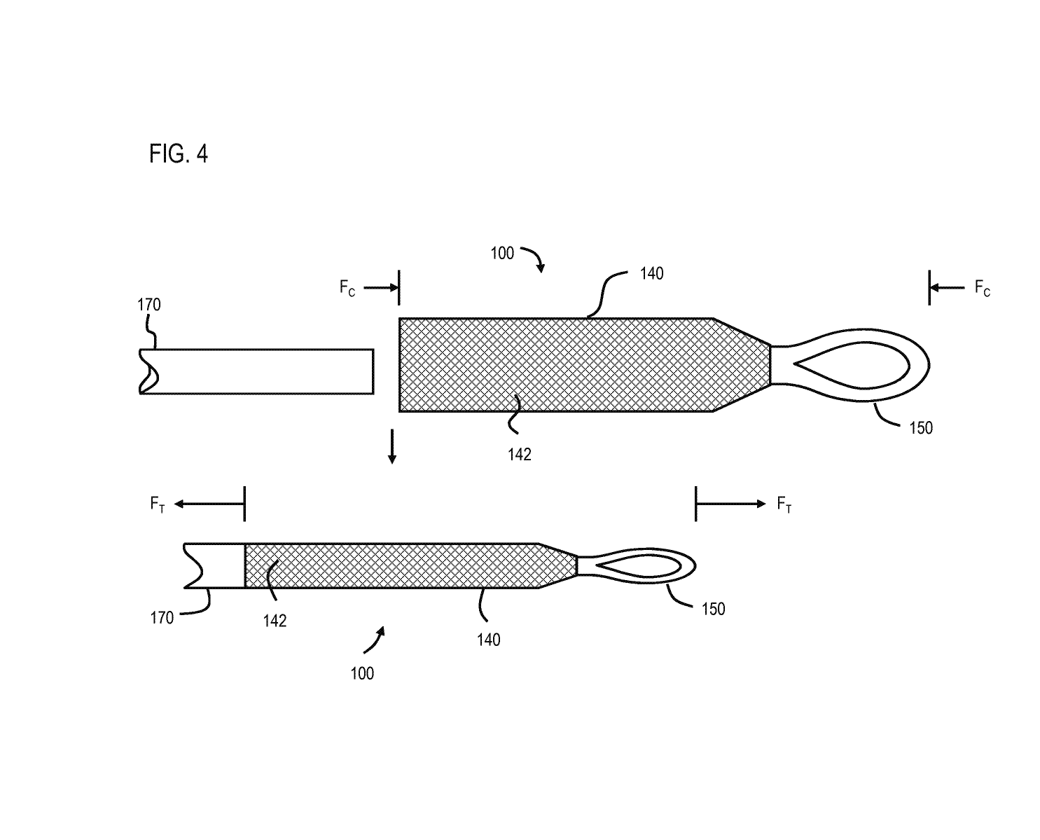

FIG. 4 illustrates the process for securing a cable 170 in accordance with one exemplary embodiment. The pulling apparatus 100 is illustrated as having a compression portion 140 formed using a net 142, or netting material. The pulling apparatus 100 also includes a connector 150 attached to one end. According to at least one embodiment, the compression portion 140 is sized relative to the diameter of the cable 170. For example, if the cable has a 10 mm diameter, a pulling apparatus 100 with a compression portion 140 having a diameter of 11 mm in the normal position P1 can be selected.

In order to easily receive the cable 170, a compression force Fc is applied to both ends of the pulling apparatus 100 along a longitudinal direction. This causes the compression portion 140 to expand in a radial direction. Depending on the specific material selected to construct the net 142 of the compression portion 140, the amount of expansion could vary, for example, between 1 mm and 3 mm. Such an expansion allows the cable 170 to be quickly and easily inserted into the compression portion 140. Once the cable 170 is fully inserted, a tensile force Ft is applied to both ends of the pulling apparatus 100. The compression portion 140 contracts in response and the diameter is reduced. The compression portion 140 thus becomes substantially the same size as the cable 170. By way of example, if protrusions 160 are formed on the inner surface of the compression portion 140, they would be forced into contact with the cable 170. As previously discussed, however, the compression portion 140 may be configured to incorporate other features, such as one or more grooves, concave-type patterns, suction cups, etc. The cable would thus be securely retained within the compression portion 140, and may be directed through a passage (not shown) by attaching a guide to the connector and pulling the guide through the passage.

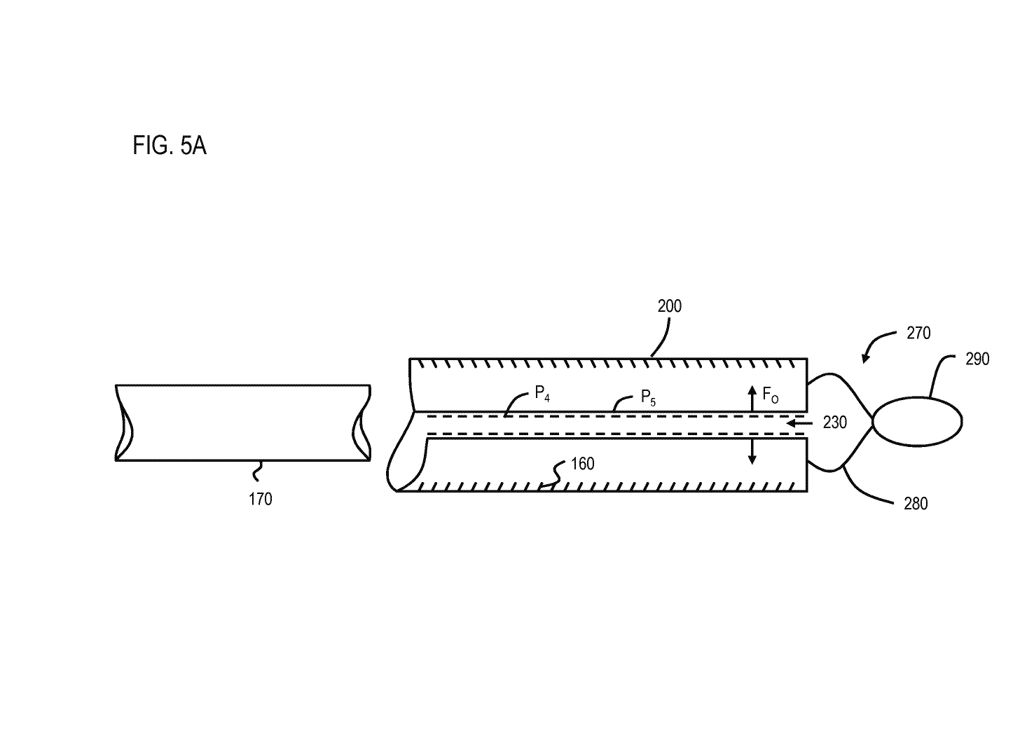

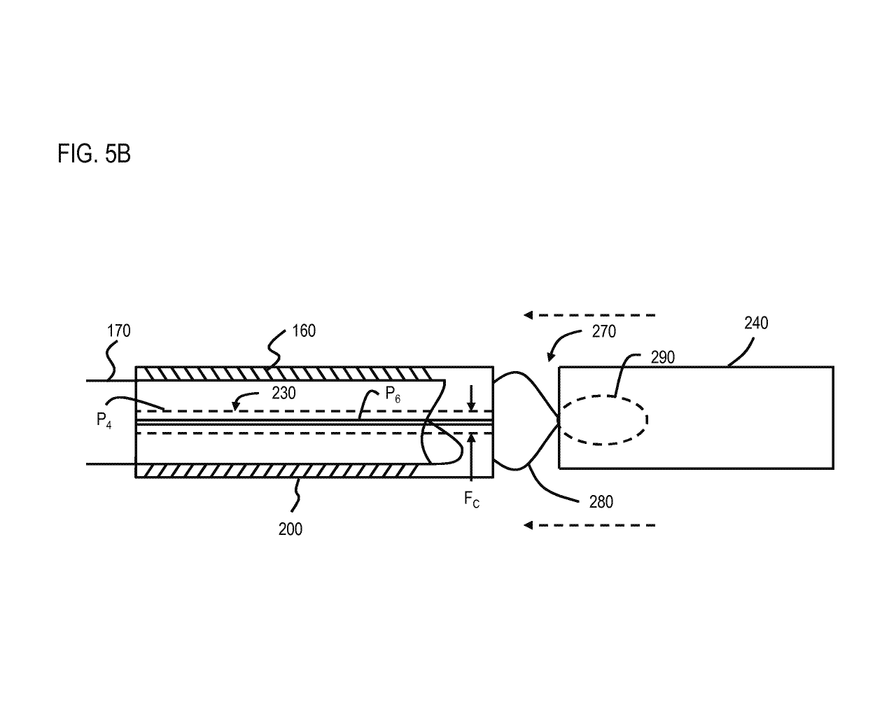

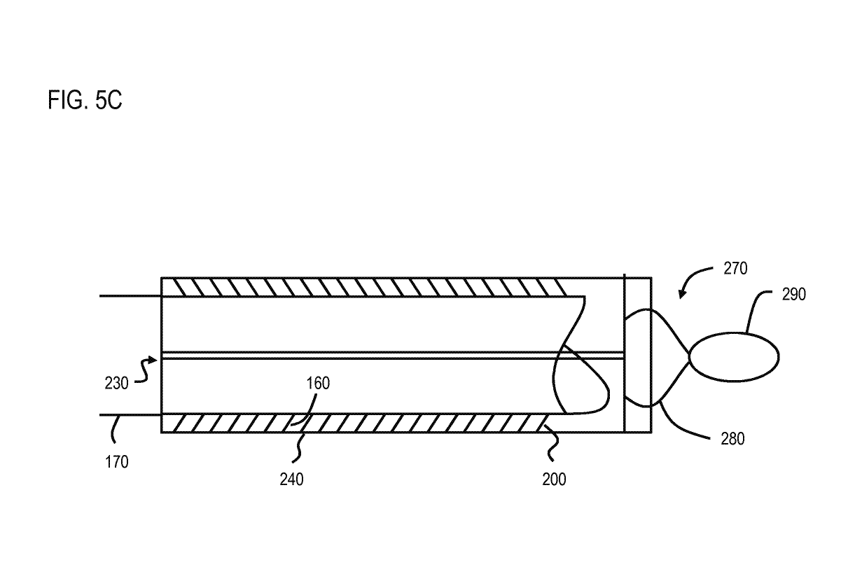

FIGS. 5A-5C illustrate the process for securing a cable 170 in accordance with another exemplary embodiment. The pulling apparatus 100 is configured to include a compression sleeve 200 and an outer jacket 240. The compression sleeve 200 includes a longitudinal slit 230 which allows it to be expanded or contracted, as well as a connecting portion 270 which facilitates attachment of a guide when the cable 170 must be pulled. Alternatively, the connecting portion can be omitted if the cable 170 is blown through the passage.

According to one or more embodiments, the compression sleeve 200 and the size of the longitudinal slit 230 are selected based on the size of the cable 170. For example, if the cable 170 has a diameter of 10 mm, various options exist for the compression sleeve 200 in order to properly receive and secure the cable 170. The compression sleeve 200 can have a diameter of 10 mm and the longitudinal slit 230 can be 1-2 mm in width. Thus, the compression sleeve 200 could be enlarged to easily receive the cable 170 and compressed to a minimum diameter of about 8 mm. The compression sleeve 200 can also have a diameter that is smaller than the cable diameter if the longitudinal slit 230 and material properties support sufficient enlargement. Conversely, the compression sleeve 200 can have a relatively greater diameter (e.g., 14 mm) with a longitudinal slit 230 having a width of about 4-5 mm. Furthermore, as previously discussed, the longitudinal slit 230 can also occupy only a portion of the compression sleeve 200. Such a configuration could, under certain circumstances, affect the degree of which the compression sleeve may be opened or closed, but also ensures a predetermined level of tension.

According to at least one embodiment, the compression sleeve 200 can include one or more protrusions 160 which assist in securing the cable 170. When a compression force Fc is applied to close the compression sleeve 200, the longitudinal slit 230 is force to the positions P6 and the protrusions 160 make contact with the cable 170, as shown in FIG. 5B. Furthermore, it can be seen that the position P6 results in a smaller width than position P4 (normal position) for the longitudinal slit 230. The compression sleeve 200 is then inserted into the outer jacket 240. According to at least one embodiment, the outer jacket 240 is selected so as to create a frictional fit against the compression sleeve 200 and prevent expansion of the compression sleeve 200.

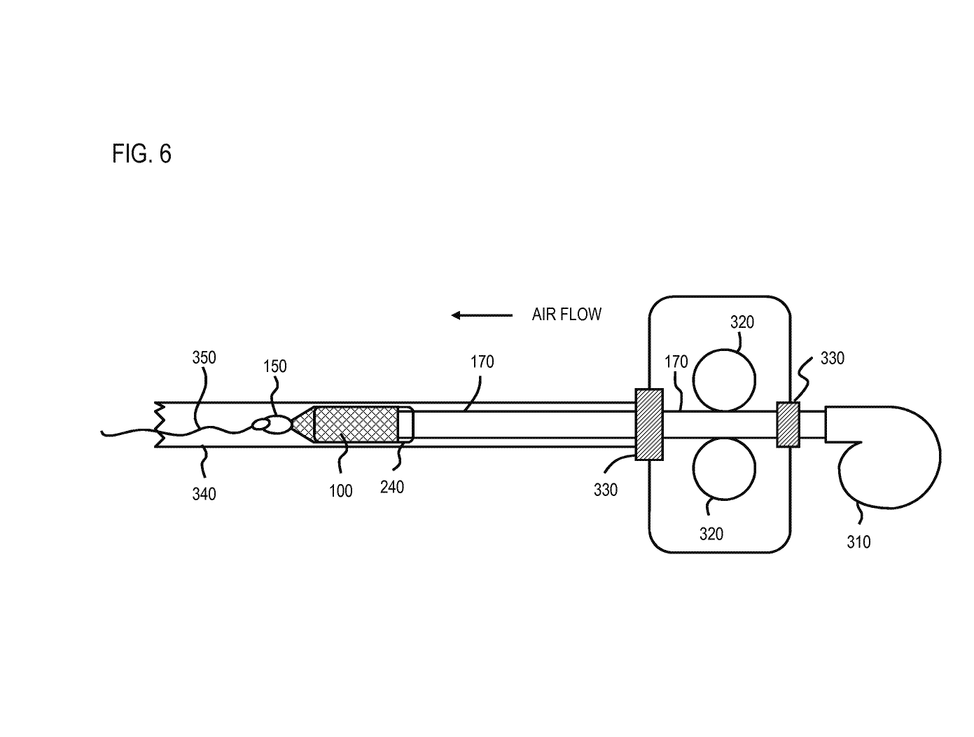

FIG. 6 illustrates a system capable of installing cables using a pulling apparatus 100, in accordance with at least one embodiment. By way of example, the cable 170 shown in FIG. 6 must be guided through a passage, such as a microduct 340. Such microducts 340 can extend for significant lengths within large business and residential buildings. The microducts 340 can also contain numerous curves and/or bends (not shown) in order to facilitate deployment within a building without damaging and/or disturbing existing cables. Such directional changes combined with the length of the microduct 340 make it difficult to simply push a cable 170 completely through.

According to one or more embodiments, a thread 350 extending the length of the microduct 340 can be used to safely pull and guide the cable 170. Specifically, the pulling apparatus 100 can be used to secure the cable 170 within the compression portion 140. Next, the thread 350 can be attached to the connector 150 at the end of the pulling apparatus 100. The pulling apparatus 100 is then inserted into the entrance, or first end, of the microduct 340. The thread 350 can then be pulled from the exit in order to deploy the cable 170. According to at least one embodiment, even if the cable 170 encounters some resistance, the pulling force of the thread 350 creates a tensile force which further decreases the diameter of the compression portion 140, thereby increasing the grip on the cable 170.

According to at least one embodiment, a jetting system 300 can be used to blow the cable 170 through the microduct 340 without requiring any thread 350. Under such conditions, the outer jacket 240 is slid over the compression portion 140 such that a tight fit is created. As illustrated in FIG. 6, the compression portion 140 has a tapered end which extends beyond the outer jacket 240. When, blowing the cable 170, however, it is possible to have the compression portion 140 flush with the outer jacket 240 or contained entirely within the outer jacket 240. Accordingly, the outer jacket 240 can include a tapered end as shown in FIG. 3.

By way of example, such a jetting system 300 can include a cable dispenser 310 which houses a spool of the necessary cable 170 and one or more rollers 320 to feed the cable 170 through the microduct 340. The rollers 320 are contained in a housing 360 which is pressurized to generate an air jet into the microduct 340. One or more seals 330 can be provided to maintain a required pressure as the air is blown into the microduct 340. Furthermore, although not shown in the FIG. 6, a restrictor can also be provided at the exit, second end, of the microduct in order to maintain a desired pressure and air flow. According to at least one embodiment, the jetting system 300 can also be used in conjunction with the thread 350. Thus, the thread 350 can be used to pull the cable 170, for example, under conditions where a turn is encountered and the air jet is insufficient to continue moving the cable 170 through the microduct 340.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. An apparatus comprising:
a body having a hollow interior, and including a proximal end and a distal end;
a compression portion defined by at least a portion of the body for releasably securing an article; and
a connector attached to the distal end of the body.

2. An apparatus of claim 1, wherein the compression portion comprises a netting material.

3. An apparatus of claim 2, wherein the netting material has a biaxial braid pattern.

4. An apparatus of claim 2, wherein the netting material comprises metal fibers.

5. An apparatus of claim 2, wherein the netting material comprises nylon fibers.

6. An apparatus of claim 1, wherein the compression portion includes a plurality of protrusions on an inner surface thereof.

7. An apparatus of claim 6, wherein at least some of the protrusions from the plurality of protrusions have a reverse catch cross-sectional shape.

8. An apparatus of claim 1, wherein the compression portion comprises:
a compression sleeve having a longitudinal slit along at least a portion thereof and
an outer jacket sized to receive the compression sleeve therein.

9. An apparatus of claim 8, further comprising a plurality protrusions formed on an interior surface of the compression sleeve.

10. An apparatus of claim 9, wherein one or more of the protrusions are contiguous in a circumferential direction.

11. An apparatus of claim 9, wherein at least some of the protrusions from the plurality of protrusions have a reverse catch cross-sectional shape.

12. An apparatus of claim 1, wherein the article is a cable.

13. A method comprising:
receiving an article in a proximal end of a pulling apparatus having a hollow interior; and
securing the cable using a compression portion of the pulling apparatus,
wherein the article is prevented from being removed from the pulling apparatus when secured using the compression portion.

14. A method of claim 13, wherein the securing comprises:
applying a compression force along an axial direction of the pulling apparatus to increase an internal diameter thereof; and
applying a tensile force along the axial direction of the pulling apparatus to engage one or more protrusions from an internal surface of the compression portion with the article.

15. A method of claim 13, wherein the compression portion of the pulling apparatus includes a slit portion, and the receiving comprises:
expanding the compression portion along the slit; and
receiving the article in the compression portion.

16. A method of claim 15, wherein the securing comprises:
applying a compression force along a radial direction of the compression portion to engage one or more protrusions from an internal surface of the compression portion with the article; and
inserting the compression portion into an outer jacket,
wherein the outer jacket is sized to maintain a predetermined diameter for the compression portion.

17. A method comprising:
inserting a cable into a proximal end of a pulling apparatus having a hollow interior;
securing the cable using a compression portion of the pulling apparatus;
inserting the pulling apparatus and cable into a first end of a microduct; and
guiding the pulling apparatus and cable to a second end of the microduct.

18. A method of claim 17, wherein the guiding comprises:
attaching a thread which extends a length of the microduct to a distal end of the pulling apparatus; and
pulling the thread to the second end of the microduct, thereby facilitating passage of the pulling apparatus and cable.

19. A method of claim 17, wherein the guiding comprises:
applying an air jet through the first end of the microduct; and
blowing the pulling apparatus and cable to the second end of the microduct.

20. A method of claim 17, wherein the guiding comprises:
attaching a thread which extends a length of the microduct to a distal end of the pulling apparatus;
applying an air jet through the first end of the microduct; and
simultaneously blowing the pulling apparatus and cable to the second end of the microduct while pulling the thread to the second end of the microduct.
